(19) United States
(12) Patent Application Publication
(10) Pub. No.: US 2022/0136530 A1
(43) Pub. Date: May 5, 2022

(54) SYSTEMS AND METHOD FOR PRESSURIZING A FLUID TO PERFORM AN OPERATION OF A MACHINE

(71) Applicant: Deere & Company, Moline, IL (US)

(72) Inventors: Michael J. Cliff, Coffeyville, KS (US); Steven R. Fliearman, Coffeyville, KS (US)

(21) Appl. No.: 16/949,550

(22) Filed: Nov. 3, 2020

(51) Int. Cl. F15B 1/02; F15B 1/027

(52) U.S. Cl. CPC F15B 1/024; F15B 1/027

(57) ABSTRACT

Systems, methods, and apparatuses for operating a machine using energy stored in a compressed gas are disclosed. Energy stored in the compressed gas may be used to pressurize a fluid, such as transmission fluid, and the pressurized fluid may be used to effectuate an operation of the machine, such as a transmission, and the operation of the machine may involve shifting of the transmission. The gas may be compressed by a first fluid using a second fluid, and the two fluids are be prevented from being mixed together.

### FIELD OF THE DISCLOSURE

The present disclosure relates generally to operation of a machine and, particularly to operation of vehicle transmissions.

### BACKGROUND OF THE DISCLOSURE

A vehicle transmission functions to transfer power from a power source, such as an engine, to a driveshaft to power a vehicle. The transmission is operable to alter a speed and torque applied to the driveshaft in relation to engine speed and torque.

### SUMMARY OF THE DISCLOSURE

A first aspect of the present disclosure is directed to a system for pressuring a fluid used to perform an operation of a machine. The system may include a first fluid and an accumulator in fluid communication with the first fluid. The accumulator may contain a gas that is compressible in response the pressurized first fluid, and the first fluid may be selectively flowable from the accumulator in response to the compressed gas to a machine to facilitate an operation of the machine.

A second aspect of the present disclosure is directed to method of operating a machine. The method may include compressing a gas within an accumulator to a first pressure with a first fluid; selectively pressurizing the first fluid with the compressed gas to apply the first fluid to the machine; and performing an operation of the machine with the pressurized first fluid.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is a schematic diagram of an example system used to provide hydraulic pressure selectively to operate a function of a machine, according to some implementations of the present disclosure.

FIG. 2 is a schematic view of an example accumulator, according to some implementations of the present disclosure.

FIG. 3 is a flow chart of an example method for using an accumulator to perform an operation of a machine, according to some implementations of the present disclosure.

FIG. 4 is a block diagram illustrating an example computer system used to provide computational functionalities associated with described algorithms, methods, functions, processes, flows, and procedures as described in the present disclosure, according to some implementations of the present disclosure.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, or steps described with respect to one implementation may be combined with the features, components, or steps described with respect to other implementations of the present disclosure.

The present disclosure is directed to systems, methods, and apparatuses for operating a machine using energy stored in an accumulator. Particularly, the present disclosure is directed to using the energy stored in an accumulator to perform a shifting operation of a transmission. For example, in some implementations, the energy is stored in a compressed gas of a hydraulic accumulator. The gas is compressed to a selected pressure in response to a first fluid pressurized intermittently by a pump. The energy stored in the compressed gas, in turn, pressurizes a fluid, such as transmission fluid, which is used to effectuate shifting of the transmission. In some instances, the pump is a pump assembly that includes a motor portion operated by a second fluid and a pump portion that pumps the first fluid in response to operation of the motor portion. The pressure applied to the gas is selected to correspond to an energy level that provides for a selected number of operations of a transmission, particularly a selected number of shifting operations of the transmission.

While transmission shifting is described in the examples provided herein, the scope of the disclosure and the applicability thereof is not limited to transmissions and the operation of transmissions. Rather, the disclosure encompasses operations of other types of machines, such as braking systems or steering systems of articulated vehicles (such as an articulated dump truck). Consequently, although the following description is made in the context of transmissions and the operation thereof, such as shifting of the transmission, the scope of the disclosure is not limited thereto.

The present disclosure provides for an accumulator that provides fluidic pressure used to actuate a machine, such as a clutch of a transmission to perform a shifting operation. The accumulator avoids the use of a separate, continuously operating pump. Because actuation of the machine may be intermittent, such a pump results in inefficiency, excessive fuel consumption, and the generation of heat. By avoiding the use of a continuously operating pump, the energy and cost associated with performing an operation of the machine is reduced.

Examples provided herein are made in the context of system hydraulic pressure being used to pressurize a fluid. System hydraulic pressure is used to operate, for example, various components of a vehicle, such as an agricultural vehicle, a construction vehicle, or a forestry vehicle, or another type of machine. The various components of the hydraulic system may include hydraulic actuators, motor-generators, or other components that operate using hydraulic fluid. The present disclosure encompasses intermittently pressurizing a fluid used to compress a gas within an accumulator using the system hydraulic pressure. Further, the scope of the present disclosure also encompasses other ways and devices to pressurize a fluid that is used to compress the gas within an accumulator. For example, an electric pump may be utilized to pressurize a fluid to compress a gas within an accumulator.

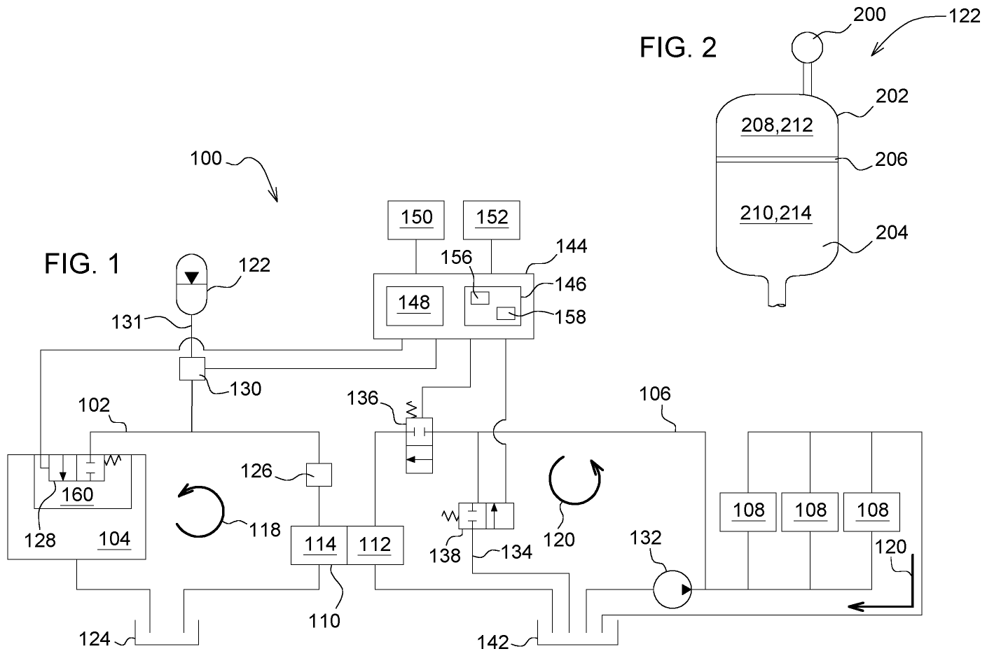

FIG. 1 is a schematic view of an example system 100 that functions to operate a transmission. The system 100 includes a first fluid circuit 102 that includes a first fluid used to operate a function of a transmission 104. Particularly, the first fluid is used to perform a shifting operation of the transmission 104, such as by being used to operate a clutch 160 of the transmission 104. The clutch 160 includes a valve 128 that operates selectively to open to permit passage of the pressurized first fluid to operate the clutch and to close to prevent passage of the pressurized first fluid. In some instances, the first fluid is a transmission fluid. The system 100 also includes a second fluid circuit 106. The second fluid circuit 106 includes a second fluid. In some instances, the second fluid is different from the first fluid. The second fluid is used to pressurize the first fluid, thereby producing a fluid flow of the first fluid in the first fluid circuit 102. In some implementations, the second fluid is hydraulic oil, and the second fluid circuit 106 is or is part of a hydraulic system that is used to operate one or more actuators, hydraulic motor-pumps, or any other type of hydraulically operated component of the vehicle. The devices operated by the second fluid are collectively referred to herein as “hydraulic components 108”. As explained earlier, the vehicle may be, for example, an agricultural vehicle, a construction vehicle, or a forestry vehicle. However, other types of vehicles or machines that utilize a transmission are also within the scope of the present disclosure.

A pump assembly 110 couples the first fluid circuit 102 and the second fluid circuit 106. In some implementations, the pump assembly 110 is a hydraulic motor-pump that includes a motor portion 112 and a pump portion 114. In some implementations, the motor portion 112 and the pump portion 114 are coupled, such as via a shaft. Flow of the second fluid operates the motor portion 112, which, in turn, operates the pump portion 114. Consequently, flow of the second fluid in the second fluid circuit 106 generates fluid flow of the first fluid in the first fluid circuit 102. A first arrow 118 indicates a direction of circulation of the first fluid in the first fluid circuit 102, and a second arrows 120 indicates a direction of flow of the second fluid in the second fluid circuit 106.

In addition to the transmission 104, the first fluid circuit 102 also includes an accumulator 122 and a reservoir 124 in which a portion of the first fluid is collected until use. A valve 126 is disposed upstream of the accumulator 122. The valve 128 provided in the clutch is disposed downstream of the accumulator 122. In some implementations, the valve 128 may be provided external to the clutch 160 and disposed downstream of the accumulator 122 between the accumulator 122 and the transmission 104. In some implementations, one or both of the valve 126 and the valve 128 are solenoid operated valves. For example, in some implementations, one or both of the valve 126 and the valve 128 may be a two-position, solenoid operated valve. In a first position, fluid is permitted to flow through the respective valve, and, in a second position, fluid is prevented from flowing through the valve. In other implementations, the valve 126 may be a check valve (also referred to as “one-way” valve) that permits flow of the first fluid in the direction of arrow 118 but prevents flow of the first fluid in a direction opposite of arrow 118. Thus, the valve 126 may be a one-way valve that prevents backflow of the first fluid. In still other implementation, the valves 126 and 128 may be other types of valves.

When charging of the accumulator 122 is desired, the pump assembly 110 is operated, as described herein, to pressurize the first fluid; the valve 128 is placed in a closed configuration; and the valve 126 is placed in an open configuration. Where the valve 126 is a one-way valve, positioning of the valve 126 may be omitted, as the valve 126 would automatically provide for fluid flow in the direction of arrow 118 and prevent fluid flow in the direction opposite of arrow 118. The pressurized first fluid would enter the accumulator 122 and compress the gas, such as to a desired pressure. When flow of the first fluid using the stored energy in the compressed gas is desired, the valve 128 is placed in the open position, and the valve 126 is placed in the closed position. Again, where valve 126 is a check valve, active positioning of the valve 126 is unnecessary. The compressed gas expands, forcing a portion of the first fluid out of the accumulator 122 towards the transmission 104. The portion of the first fluid pressurized by the compressed gas is used to perform a shifting operation of the transmission 104. Thereafter, the portion of the first fluid is permitted to return to the reservoir 124.

In some implementations, the valve 128 may remain in an open position during charging of the accumulator 122. For example, as the accumulator 122 is being charged using the pressurized first fluid (i.e., as the first fluid is being used to compress the gas contained in the accumulator), a shifting operation of the transmission 104 may be desired. Consequently, the valve 128 is cycled, e.g., open for an amount of time to provide operation of the clutch and closed at some time thereafter, as the first fluid is passed through the first circuit 102 to charge accumulator 122. The valve 128 is operated, such as via a signal from controller 144, described in more detail below, to permit a selected amount of the first fluid to pass and operate the clutch 160 even as the accumulator 122 is being charged. For example, the valve 128 may be operated such that a pressure of the first fluid introduced to the clutch 160 is at a level less than a pressure applied to the first fluid by the pump 114. Consequently, the clutch 160 and transmission 104 are operated safely even as the first fluid charges the accumulator 122.

In some implementations, a pressure imparted to the first fluid by the pump 114 is sufficient to both charge the accumulator 122 as well as simultaneously perform a shifting operation of the transmission 104. Shifting the transmission includes holding the clutch 160 in an actuated configuration for a desired period of time. Thus, the valve 128 is positionable into and capable of being held in the open configuration by the first fluid for a desired period of time in order to actuate the clutch 160. The clutch 160 is also capable of being held in the actuated configuration (i.e., in response to holding the valve 128 in the open configuration) during charging of the accumulator 122 as well as when the accumulator 122 is not being charged. Consequently, the clutch 160 is capable of being held in the actuated configuration for a desired period of time using the energy stored in the compressed gas or the energy of the pressurized first fluid provided by the pump 114. In some implementations, the valve 128 has a default closed configuration, and the valve 128 is opened when a shifting operation is desired.

In some implementations, holding the clutch 160 in the actuated position does not involve hydraulic leakage in which a portion of the first fluid flows past the clutch 160 and transmission 104 back to the reservoir 124. Where hydraulic leakage does not occur, the energy provided by the compressed gas of the accumulator 122 maintains the hydraulic pressure of the first fluid used to actuate and hold the clutch 160 in the actuated configuration for a desired period of time. Where leakage is present, the energy stored in the accumulator 122 maintains the clutch 160 in the actuated configuration until recharging of the accumulator 122 is indicated. When recharging of the accumulator 122 occurs, the pressurized first fluid, provided by operation of the pump 114, is able to both recharge the accumulator 122 as well as maintain the clutch 160 in the actuated configuration. Thus, the clutch 160 is continuously held in the actuated configuration notwithstanding recharging of the accumulator 122. Although the present example is made in the context of the clutch 160 and transmission 104, the described capability to maintain actuation for a desired period of time is applicable to other machines. This described functionality provides improved energy conservation in that the pump 114 is operated when recharging of the accumulator 122 is needed and is then deactivated once the compressed gas in the accumulator 122 is pressurized to the selected level. Thus, the pump 114 is operated intermittently and not continuously, thereby conserving energy.

The first fluid circuit 102 also includes a pressure sensor 130. The pressure sensor 130 detects a pressure of a gas within the accumulator 122 or a pressure that is indicative of the gas pressure within the accumulator 122. In the illustrated example, the pressure sensor 130 detects a pressure of the first fluid, which is indicative of the gas pressure when the first fluid is being expelled from the accumulator 122. For example, the pressure sensor 130 detects a pressure of the first fluid within a conduit 131 of the first fluid circuit 102 used to conduct the first fluid, as shown in FIG. 1. The pressure sensor 130 generates a pressure signal corresponding to the gas pressure and sends the pressure signal to a controller, such as controller 144 described in more detail below.

FIG. 2 is a schematic view of the example accumulator 122. In this example, a pressure of the gas is detected by a pressure sensor 200 in communication with the gas contained within the accumulator 122. Thus, in this example, the pressure sensor 200 directly detects the pressure of the gas within the accumulator 122, while the pressure sensor 130 indirectly detects the pressure of the gas within the accumulator 122. However, the scope of the disclosure is not limited to detection of the gas pressure as provided in these examples. Rather, other ways of determining the pressure of the gas within the accumulator 122 are also within the scope of the present disclosure.

As shown in FIG. 2, the accumulator 122 includes a housing 202 that defines a cavity 204. The cavity 204 is divided by a partition 206. The partition 206 divides the cavity 204 into a first portion 208 and a second portion 210. In some implementations, the partition 206 is a flexible partition. For example, the partition 206 may be a flexible diaphragm that is fixed to the housing 202 along a perimeter of the flexible diaphragm. As the pressure within the accumulator 122 changes, the partition 206 may flex, altering a volume of a first portion 208 and the second portion 210. In other implementations, the partition 206 may be a piston that is slideable within the housing 202 in response to pressure changes, thereby altering a size of the first portion 208 and the second portion 210.

A gas 212 is disposed in the first portion 208, and the first fluid 214 is received into the second portion 210. As the pressurized first fluid 214 is introduced into the second portion 210 of the cavity 204, the partition 206 is displaced, distorted, or otherwise moved within the cavity 204, causing the gas 212 to be compressed when the pressure of the first fluid 214 is greater than the pressure of the gas 212. The pressure sensor 200 detects the pressure of the gas 212. Conversely, when the pressure of the first fluid 214 is less than the pressure of the gas 212, the gas 212 expands, displacing the partition 206, and forcing at least a portion of the first fluid 214 out of the accumulator 122.

Referring again to FIG. 1, in addition to the hydraulic components 108, the second fluid circuit 106 also includes a pump 132, a bypass 134, valve 136, valve 138, and a reservoir 142. The second fluid that passes through the bypass 134 and the pump 132 is returned to the reservoir 142. In some implementations, one or more of the valves 136 and 138 are solenoid operated valves. For example, in some instances, one or more of the valves 136 and 138 are two-position solenoid operated valves. In still other implementation, the one or more of the valves 136 and 138 may be other types of valves. The pump 132 draws the second fluid from the reservoir 142 and circulates the second fluid through the second circuit 106. Particularly, the pump 132 generates a flow of the second fluid that is distributed to the various hydraulic components 108 to operate the hydraulic components 108. Additionally, the second fluid is provided to the pump assembly 110 or the bypass 134 or both, depending upon a position of the valves 136 and 138. For example, in some instances, such as when charging of the accumulator 122 is desired, the valve 136 is placed in an open configuration that allows the second fluid to pass through the valve 136, and the valve 138 is placed in a closed configuration, preventing the second fluid from passing through the valve 138. As a result, no fluid is permitted to pass through the bypass 134. With the valves 136 and 138 in the described configurations, the second fluid is directed to the pump assembly 110, which generates a fluid flow of the first fluid in the first fluid circuit 102.

With the valve 136 placed in the closed configuration and the valve 138 placed in the open configuration, the pressurized second fluid is directed through the bypass 134, thereby preventing operation of the pump assembly 110 and, consequently, pressurization of the first fluid within the first fluid circuit 102. In some instances, both the valve 136 and the valve 138 may be in the open configuration, allowing a portion of the second fluid to flow to the pump assembly 110, and particularly to the motor portion 112 of the pump assembly 110, to operate the pump assembly 110, and a portion of the second fluid is directed through the bypass 134. In such instances, an amount of the second fluid used to operate the pump assembly 110 is reduced. In some instances, one or both of the valves 136 and 138 may be variable solenoid operated valves that permit opening the valves 136 and 138 a variable amount. By opening one or both of the valves 136 and 138 a variable amount, an amount of the second fluid (e.g., a flow rate of the second fluid) reaching the pump assembly 110 is controlled.

The system 100 also includes a controller 144. In some implementations, the controller 144 is an electronic computer system that operates to control various aspects of the system 100 based, at least in part, on received information. Particularly, in the illustrated example, the controller 144 receives signals, such as from the pressure sensor 130, and sends signals to controlled components of the system 100, such as to actuate the valves 126, 128, 136, and 138. However, as explained earlier, the valve 126 may be a passive check valve that does not require active control to prevent back flow of fluid. The signals may be sent, received, or both over a wired or wireless connection. Further, as also explained above, operation of the valve 128 may be performed by a different controller to control operations of the transmission 104, such as shifting functions of the transmission 104.

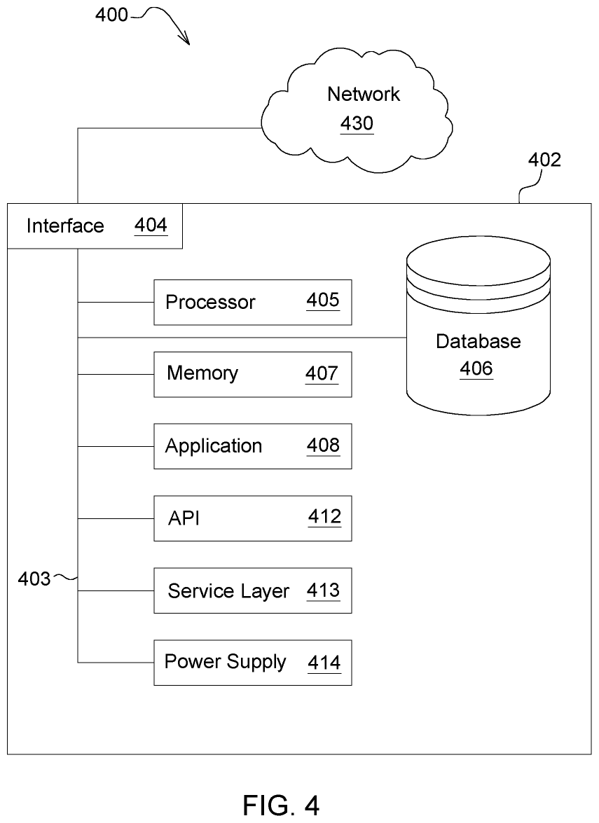

The controller 144 is or forms a part of a computer, such as computer 402 described below and as illustrated in FIG. 4. Additionally, in some implementations, the controller 144 forms part of a computer system, such as computer system 400 described below and illustrated in FIG. 4. The controller 144 includes a memory 146 and a processor 148. Although the memory 146 is shown as being included in the controller 144, in some implementations, the memory 146 may be separate from the controller 144 and communicably coupled to the controller 144 via a wired or wireless connection. For example, in some implementations, the memory 146 may be remotely located.

The memory 146 communicates with the processor 148 and is used to store software and information (such as in the form of data). The processor 148 is operable to execute programs and receive information from and send information to the memory 146. Although a single memory 146 and a single processor 148 are illustrated, in other implementations, a plurality of memories, processors, or both may be used. A display 150 is coupled to the controller 144. The display 150 may be used to present information to a user or, where the display is or includes a touch screen, the display 150 may be used as an input device. The display 150 may include a graphical user interface, described in more detail below, that allows a user to interface with applications executed by the processor 148. An input device 152 is also coupled to the controller 144. A user may use the input device 152 to provide inputs (which may include information) to the controller 144. The memory 146 stores programs, such as application 156, and other information 158 (such as in the form of data).

The controller 144 controls operation of the system 100, such as actuation of the valves 128, 136, and 138 based, at least in part, on sensed information provided by the pressure sensor 130 and another input, described in more detail below, to control charging the accumulator 122 and performing a shifting operation of the transmission 104 using the energy stored in the compressed gas in the accumulator 122. In some implementations, the controller 144 may be or be part of a transmission controller that operates functions of the transmission, including shifting functions. For example, a transmission controller provides signals to trigger shifting of a transmission. In some instances, the signals operate a valve, such as valve 128, to permit passage of hydraulic fluid to operate a clutch, resulting in shifting of the transmission. In other implementations, the controller 144 may be separate from a transmission controller and operates to control charging of the accumulator 122, and a separate controller is used to control operation of the transmission 104. Where multiple controllers are used, the different controller may communicate with each other to provide for coordinated operation of the system 100.

In the illustrated example, valve 126 is a passive check valve and does not require active control. Consequently, the controller 144 is not coupled to the valve 126 to control the operation thereof. Rather, the valve 126 operates passively to permit flow of fluid in a single direction. In other implementations, the valve 126 is a controllable valve, for example, solenoid operated valves. In such instances, the controller 144 is operable to alter a configuration of the valve 126 to effectuate the charging of the accumulator and the shifting of the transmission in a manner as described herein.

Example operation of the system 100 is described in more detail below. In operating the valves in the manner provided, the controller 144 is operable to pressurize the accumulator 122 and perform shifting operations of the transmission 104. Again, although the machine operation described in this example is the shifting of a transmission, the methods and systems within the scope of the present disclosure are applicable to performing other types of machine operations.

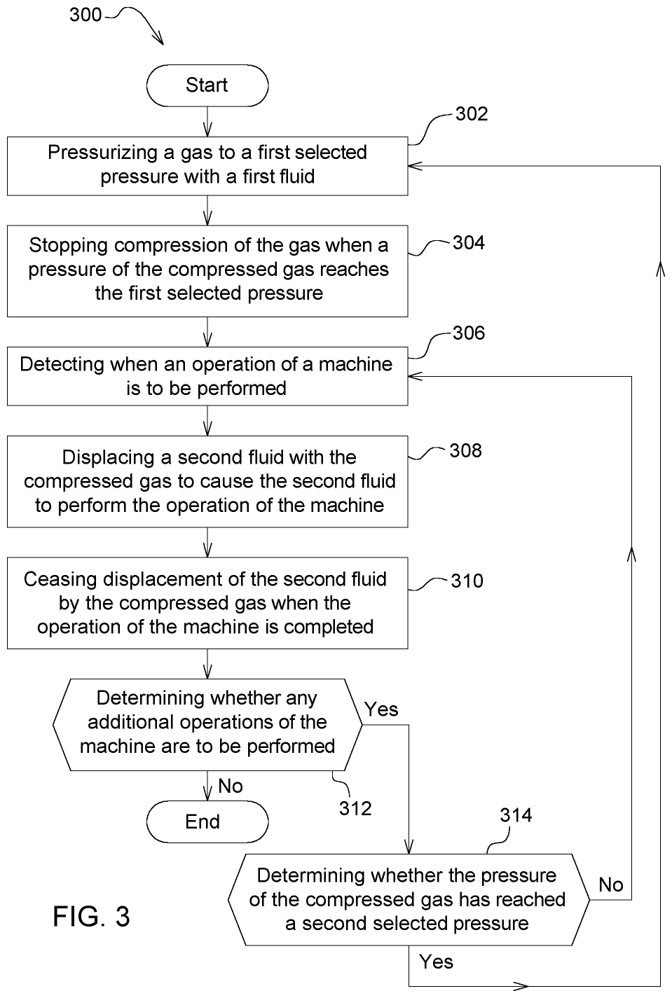

FIG. 3 is a flow chart of an example method 300 for using an accumulator to perform an operation of a machine. In this example, the method 300 is directed to performing shifting operations of the transmission using an accumulator. In the course of describing the method 300 reference may be made to the example system 100 and parts thereof. The scope of the disclosure, though, is not so limited. Rather, the method 300 is applicable to other systems within the scope of the present disclosure. Thus, system configurations other that the configuration of example system 100 may be used and are within the scope of the present disclosure. Further, the example method 300 is made in the context of a first fluid and a second fluid used to pressurize the first fluid. In other implementations, the second fluid may be omitted, and the first fluid may be pressurized in other ways. For example, in some instances, the first fluid may be pressurized using an electrically operated pump. Consequently, the scope of the present disclosure encompasses numerous ways used to pressurize the first fluid.

At 302, a gas is pressurized with a first fluid to a first selected pressure. The first selected pressure provides for a selected number of operations of a machine before the gas is to be re-pressurized. In some implementations, the gas is disposed in a hydraulic accumulator 122, and the first fluid is introduced into the accumulator to compress the gas until the first selected pressure is obtained. The accumulator 122 forms part of a first fluid circuit 102 that contains the first fluid. In some implementations, the gas is nitrogen gas. However, in other implementations, the gas may be another type of gas or mixture of gases. In some implementations, a pre-charge pressure is applied to the gas. The pre-charge pressure is a pressure applied to the gas in the absence of influence applied by the first fluid. Thus, the pre-charge gas pressure defines an initial pressure of gas in the accumulator unaffected by a force exerted by the first fluid. For example, in some implementations, the pre-charge gas pressure may be within a range of 200 pounds per square inch (psi) (1.38 Megapascals (MPa)) and 400 psi (2.76 MPa). This pressure range is provided merely as an example. Consequently, the pre-charge gas pressure may be set to other pressure values.

In some implementations, the first fluid is pressurized with the use of a pressurized second fluid. The second fluid is provided in a second fluid circuit 106, and, in some implementations, the second fluid circuit 106 is a hydraulic system of a machine that is used to operate one or more hydraulic components 108. The second fluid is pressurized using, for example, a pump (such as pump 132). The second fluid is used to selectively operate a pump assembly 110 that pressurizes the first fluid. Consequently, the first fluid is selectively pressurized using the selective operation of the pump assembly 110. Additionally, as the gas is being pressurized by the first fluid, the first fluid is prevented from being provided to the machine to perform a machine operation. In the example of FIG. 1, the first fluid is prevented from being provided to the transmission 104 via valve 128.

In some implementations, the gas may be compressed to a pressure within a range of 250 psi (1.72 MPa) to 450 psi (3.10 MPa). However, this pressure range is provided merely as an example. In other implementations, the pressure range may extend to pressures lower than 250 psi (1.72 MPa) or greater than 450 psi (3.10 MPa). Further, a pressure to which the gas is compressed may be selected based on, for example, a number of operations of a machine to be performed using the energy stored in the compressed gas or a volume occupied by the gas. For example, where the first fluid is used to perform a shifting operation of a transmission, a consideration that may be used to determine the first selected pressure to which the gas is compressed is the number of shifts to be performed by the transmission using the first fluid and energy stored in the compressed gas before the compressed gas has obtained a second selected pressure. For example, the first selected pressure may be selected to provide five to 10 shifting operations. In some implementations, the first selected pressure may provide for additional or fewer shifting operations. The second selected pressure corresponds to a pressure at which the gas has insufficient energy to effectuate a further shift or another pressure. For example, in some instances, the second selected pressure may be selected to be a pressure at which the compressed gas has sufficient energy to perform a shifting operation but is at a level at which re-pressurization of the gas to the first selected pressure is desirable.

At 304, pressurization of the gas is ceased when the first selected pressure is obtained. In some implementations, the first selected pressure is detected using a pressure sensor, such as pressure sensor 130. As charging of the accumulator 122 continues, the controller 144 monitors the pressure signal received form the pressure sensor 130. In some implementations, a bypass 134 in the second fluid circuit 106 is opened in response to the detection of the first selected pressure. The bypass 134 is opened using one or more valves, such as valve 136, and 138. As described earlier, the controller 144 operates the valves 136 and 138 to direct the second fluid flow through the bypass 134 when the gas pressure within the accumulator 122 reaches the first selected pressure. As a result of operation of the one or more valves, the bypass 134 is opened, and the second fluid is prevented from operating the pump assembly 110, which ceases pressurization of the first fluid and, consequently, stops compression of the gas. The bypass 134 provides for continued operation of the first fluid circuit and, consequently, continued use of the second fluid to operate hydraulic components while avoiding continued pressurization of the first fluid.

When pressurization of the gas is ceased, the first fluid is maintained in a pressurized state by the compressed gas using valves, such as valves 126 and 128. Operation of the valves 126 and 128 is coordinated by the controller 144 to prevent backflow of the first fluid through the first fluid circuit and forward flow to the machine (i.e., the transmission 104 in the context of the example shown in FIG. 1), thereby maintaining pressurization of the gas. As explained, in some instances, the valve 126 is a passive one-way valve that prevents flow of the first fluid in a direction opposite arrow 118. In other instances, the valve 126 is an actively controlled valve, and the controller 144 positions the valve 126 in a closed position after charging of the accumulator 122, which results in compression of the gas therein, is completed. In some implementations, the first selected pressure is in the range of 3000 psi (20.7 MPa) to 3600 psi (24.8 MPa). In some implementations, the first selected pressure is in the range of 250 psi (1.38 MPa) to 450 psi (3.10 MPa). However, this pressure range is provided merely as an example. In other implementations, other pressure ranges may be used. With the valve 128 in either the open configuration (such as to hold the clutch 160 in the actuated configuration and where there is no hydraulic leakage) or the closed configuration and with the valve 126 preventing backflow, a pressure within the accumulator 122 is maintained. For example, immediately after charging of the accumulator 122, with the valve 128 in the closed configuration and valve 126 preventing backflow, the pressure maintained in the accumulator is the second selected pressure.

At 306, an indication that the machine is to be operated is detected. In the present example, the machine is the transmission 104, and the operation is shifting of the transmission 104, such as by operation of the clutch 160. For example, the controller 144 receives a signal from the transmission 104 or from another source indicating a shift is to be performed. For example, the transmission may be a part of a vehicle, and a signal to shift the transmission may be received by the controller 144 from a sensor of the vehicle, another computer or device of the vehicle, a user input (such as a user input to the vehicle), or another source whether onboard the vehicle or external to the vehicle.

At 308, the pressurized gas is used to displace a portion of the first fluid to perform the operation of the machine. In this example, when an indication that a shifting operation is to be performed is received by the controller 144, the controller 144 opens the valve 128, permitting the pressurized first fluid to flow to clutch 160, providing for a shifting operation of the transmission 104. With the valve 128 in the open configuration, the compressed gas contained in the accumulator 122 expands, expelling a portion of the first fluid contained in the accumulator 122 and forcing a portion of the first fluid to a portion of the transmission 104, such as a clutch 160. The pressurized first fluid enables the clutch 160 to operate, shifting a gear of the transmission 104.

At 310, displacing of the first fluid with the compressed gas is ceased, such as in response to completion of the operation of the machine. The controller 144 closes the valve 128 to stop actuation of the clutch 160. In implementations where hydraulic leakage is associated with maintaining the clutch 160 (or another type of machine) in the actuated configuration, closing the valve 128 prevents further expansion of the compressed gas, thereby conserving energy stored in the accumulator 122. As explained above, though, even with hydraulic leakage, the system 100 is operable to charge the accumulator 122 and maintain the clutch 160 in the actuated configuration simultaneously. Therefore, if the pressure of the compressed gas reaches a level that triggers recharging of the accumulator 122 while the clutch 160 is being held in the actuated configuration, the energy provided to the first fluid by the pump 114 as the accumulator 122 is recharged is sufficient to perform both tasks simultaneously. In implementations in which hydraulic leakage is absent, maintaining the clutch 160 in an actuated configuration does not involve loss of energy from the compressed gas. Consequently, in such implementations, energy is conserved even when the clutch is held in the actuated configuration.

Stopping expansion of the gas in the accumulator 122 stops the output of energy from the accumulator 122. Ceasing the flow of the first fluid using the accumulator 122 (i.e., expansion of the compressed gas contained therein) is triggerable in numerous ways. For example, the controller 144 may detect a signal from the transmission 104, such as a signal from a sensor associated with the transmission 104 that senses completion of the operation, impending completion of the operation, or an event or characteristic indicative of completion of the operation; an input from a user (such as a user input to the vehicle); an input from another computer or device of the vehicle; or another source whether onboard the vehicle or external to the vehicle. The received input indicates that the shifting operation is completed. In some implementations, the controller 144 stops flow of the first fluid, such as by placing the valve 128 in the closed configuration, after the passage of a selected amount of time. The amount of time may correspond to an amount of time associated with shifting the transmission, or, in the context of an operation of another machine, an amount of time associated with completion of the particular machine's operation. In other instances, the controller 144 may stop flow of the first fluid, e.g., by closing valve 128, upon a detection of a selected amount of change in the pressure of the compressed gas or upon detection of a selected pressure within a portion of a machine. For example, the valve 128 is closed when the pressure within the clutch 160 reaches a selected pressure. In some implementations, this selected pressure is less than a pressure of the first fluid provided by the accumulator 122 or by the pump 114 (such as when the valve 128 operates during charging of the accumulator 122 via the pump 114). In some implementations, when the controller 144 detects, such as with use of a pressure signal provided by pressure sensor 130, that the gas pressure has reduced by a selected amount, the controller 144 closes the valve 128 to prevent additional flow of the first fluid using the energy stored in the accumulator 122. In other instances, an indication that the machine operation (e.g., transmission shifting) is completed is signaled by receipt of an input by a user. Receipt of an input indicative that the transmission shifting is completed causes the controller 144 to move the valve 128 to the closed configuration to stop expansion of the gas within the accumulator 122, thereby conserving the energy within the accumulator 122. By stopping expansion of the gas upon completion of the machine operation, release of energy stored within the compressed gas that is not needed for the machine operation is avoided, and the remaining energy stored within the gas is conserved until needed for a subsequent machine operation. The portion of the first fluid pressurized by expansion of the compressed gas and used to perform the shifting operation returns to the reservoir 124 for later use.

At 312, a determination is made as to whether any additional operations of the machine is to be performed. For example, in the context of a transmission of a vehicle, if operation of the vehicle continues, e.g., if an engine of the vehicle continues to operate, additional shifts of the transmission may occur. Therefore, if additional operations of the machine are to be performed, e.g., if additional shifts of the transmission are likely to occur in the future, then the method 300 moves to 314. If no additional operations are to be performed, then the method 300 ends.

At 314, a determination is made as to whether the pressure of the compressed gas has reached a second selected pressure. In some implementations, the second selected pressure is greater than a pre-charge gas pressure of the accumulator. The second selected pressure is less than the first selected pressure. In the context of the described example, the controller 144 receives signals from the pressure sensor 130 indicative of the pressure of the gas within the accumulator 122. In some implementations, the pressure signal provided by the pressure sensor 130 may be continuous or sampled at a selected frequency. The controller 144 compares the received pressure signal to a second selected pressure. When the pressure of the gas reaches or drops below the second selected pressure, the controller 144 operates the system 100 to re-pressurize the compressed gas. If the pressure signal indicates that the gas pressure is above the second selected pressure, re-pressurization of the compressed gas is not initiated.

If the result of 314 is “no,” i.e., the pressure of the compressed gas is not equal to or less than the second selected pressure, then the method 300 returns to 306, and the method 300 continues as described above. If the result of 314 is “yes,” i.e., the pressure of the compressed gas is equal to or less than the second selected pressure, the method returns to 302, where the gas is re-pressurized by the first fluid as discussed above. Particularly, in the context of the present example, to re-pressurize the gas, the controller 144 sends a signal to the valves 136 and 138 to direct the second fluid to the pump assembly 110 to re-pressurize the first fluid. As described above, the pressurized first fluid is conducted into the accumulator 122, compressing the gas contained therein. As also explained earlier, in some implementations, the valves 136 and 138 may be variable valves such that the amount by which each valve is opened may be varied so that a portion of the second fluid flow is directed to the pump assembly 110 and a portion of the second fluid flow is directed through the bypass 134.

FIG. 4 is a block diagram of an example computer system 400 used to provide computational functionalities associated with described algorithms, methods, functions, processes, flows, and procedures described in the present disclosure, according to some implementations of the present disclosure. The illustrated computer 402 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or GUI).

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

At a high level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 403. In some implementations, any or all of the components of the computer 402, including hardware or software components, can interface with each other or the interface 404 (or a combination of both), over the system bus 403. Interfaces can use an application programming interface (API) 412, a service layer 413, or a combination of the API 412 and service layer 413. The API 412 can include specifications for routines, data structures, and object classes. The API 412 can be either computer-language independent or dependent. The API 412 can refer to a complete interface, a single function, or a set of APIs.

The service layer 413 can provide software services to the computer 402 and other components (whether illustrated or not) that are communicably coupled to the computer 402. The functionality of the computer 402 can be accessible for all service consumers using this service layer. Software services, such as those provided by the service layer 413, can provide reusable, defined functionalities through a defined interface. For example, the interface can be software written in JAVA, C++, or a language providing data in extensible markup language (XML) format. While illustrated as an integrated component of the computer 402, in alternative implementations, the API 412 or the service layer 413 can be stand-alone components in relation to other components of the computer 402 and other components communicably coupled to the computer 402. Moreover, any or all parts of the API 412 or the service layer 413 can be implemented as child or sub-modules of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the interface's hardware can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and can manipulate data to perform the operations of the computer 402, including operations using algorithms, methods, functions, processes, flows, and procedures as described in the present disclosure.

The computer 402 also includes a database 406 that can hold data for the computer 402 and other components connected to the network 430 (whether illustrated or not). For example, database 406 can be an in-memory, conventional, or a database storing data consistent with the present disclosure. In some implementations, database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

The application 408 can be an algorithmic software engine providing functionality according to particular needs, desires, or particular implementations of the computer 402 and the described functionality. For example, application 408 can serve as one or more components, modules, or applications. Further, although illustrated as a single application 408, the application 408 can be implemented as multiple applications 408 on the computer 402. In addition, although illustrated as internal to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion and management circuits, including recharging, standby, and power management functionalities. In some implementations, the power-supply 414 can include a power plug to allow the computer 402 to be plugged into a wall socket or a power source to, for example, power the computer 402 or recharge a rechargeable battery.

There can be any number of computers 402 associated with, or external to, a computer system containing computer 402, with each computer 402 communicating over network 430. Further, the terms “client,” “user,” and other appropriate terminology can be used interchangeably, as appropriate, without departing from the scope of the present disclosure. Moreover, the present disclosure contemplates that many users can use one computer 402 and one user can use multiple computers 402.

Described implementations of the subject matter can include one or more features, alone or in combination.

For example, in a first implementation, a computer-implemented method for operating a machine includes compressing a gas within an accumulator to a first pressure with a first fluid; selectively pressurizing the first fluid with the compressed gas to apply the first fluid to the machine; and performing an operation of the machine with the pressurized first fluid.

The foregoing and other described implementations can each, optionally, include one or more of the following features:

A first feature, combinable with any of the following features, the method further including selectively operating a pump to pressurize the first fluid.

A second feature, combinable with any of the previous or following features, wherein the pump includes a pump assembly and wherein selectively operating a pump to pressurize a first fluid includes operating the pump assembly with a second fluid to pressurize the first fluid.

A third feature, combinable with any of the previous or following features, wherein the pump assembly includes a hydraulic motor portion operated by the second fluid and a pump portion that pressurizes the first fluid in response to operation of the hydraulic motor portion.

A fourth feature, combinable with any of the previous or following features, wherein selectively pressuring the first fluid with the compressed gas to apply the first fluid to the machine includes selectively operating a first valve into a first configuration to direct flow of the pressurized first fluid to the accumulator to compress the gas and prevent flow of the first fluid to a location downstream of the accumulator.

A fifth feature, combinable with any of the previous or following features, wherein selectively pressuring the first fluid with the compressed gas to apply the first fluid to the machine includes selectively operating the first valve into a second configuration to direct flow of the first fluid to the location downstream of the accumulator.

A sixth feature, combinable with any of the previous or following features, wherein compressing a gas within an accumulator with the pressurized first fluid includes compressing the gas within the accumulator to a selected pressure with the pressurized first fluid and wherein the selected pressure is selected to accommodate a selected number of operations of the machine before recompression of the gas is performed.

A seventh feature, combinable with any of the previous or following features, wherein selectively operating a pump to pressurize a first fluid includes operating a pump with a pressurized second fluid and wherein compressing a gas within an accumulator with the pressurized first fluid includes flowing the pressurized first fluid into the accumulator in response to operation of the pump by the pressurized second fluid to compress the gas to a selected pressure and stopping flow of the pressurized first fluid upon the gas being compressed to the selected pressure.

An eighth feature, combinable with any of the previous or following features, wherein selectively pressuring the first fluid with the compressed gas to apply the first fluid to the machine includes flowing the pressurized first fluid to the machine in response to at least partial expansion of the compressed gas.

A ninth feature, combinable with any of the previous or following features, wherein the machine includes a transmission and wherein performing an operation of the machine with the pressurized first fluid includes shifting the transmission.

A tenth feature, combinable with any of the previous features, wherein selectively operating a pump to pressurize a first fluid includes detecting a pressure of the gas in the accumulator and providing for operation of the pump when the detected pressure is equal to or less than a second pressure.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Without in any way limiting the scope, interpretation, or application of the claims appearing below, a technical effect of one or more of the example implementations disclosed herein is to provide actuation of a machine, such as a transmission, while avoiding energy losses associated with a continuously operating pump that would otherwise be used to facilitate the actuation.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

While the above describes example implementations of the present disclosure, these descriptions should not be viewed in a limiting sense. Rather, other variations and modifications may be made without departing from the scope and spirit of the present disclosure as defined in the appended claims.

What is claimed is:

1. A system for pressuring a fluid used to perform an operation of a machine, the system comprising:
a first fluid; and
an accumulator in fluid communication with the first fluid, the accumulator containing a gas that is compressible in response the pressurized first fluid, the first fluid selectively flowable from the accumulator in response to the compressed gas to a machine to facilitate an operation of the machine.

2. The system of claim 1, further comprising a pressurized second fluid, the first fluid being selectively pressurized by the pressurized second fluid.

3. The system of claim 2, further comprising a pump assembly, wherein the pump assembly is selectively operated by the pressurized second fluid to selectively pressurize the first fluid.

4. The system of claim 3, further comprising:
a first fluid circuit that includes the first fluid; and
a second fluid circuit that includes the second fluid, the first fluid and the second fluid separated by the pump assembly to isolate the first fluid from the second fluid.

5. The system of claim 4, wherein the second fluid circuit comprises a fluid bypass that is selectively configurable into a first configuration in which the second fluid is permitted to operate the pump assembly and a second configuration in which the second fluid bypasses the pump assembly.

6. The system of claim 3, wherein the pump assembly comprises:
a hydraulic motor portion operated by the pressurized second fluid; and
a pump portion that pressurizes the first fluid in response to operation of the hydraulic motor portion.

7. The system of claim 1, wherein the accumulator comprises:
a first chamber containing the compressible gas; and
a second chamber configured to receive the pressurized first fluid,
wherein a size of the first chamber is alterable in response to pressure changes of the first fluid.

8. The system of claim 7, wherein the accumulator further comprises a partition separating the first chamber from the second chamber.

9. The system of claim 1, further comprising a first valve selectively configurable between a first configuration to direct the pressurized first fluid to the accumulator to compress the gas and a second configuration to direct a portion of first fluid expelled from the accumulator in response to the compressed gas away from the accumulator.

10. The system of claim 1, further comprising a check valve that operates to permit flow of the first fluid in a first direction into the accumulator to compress the gas and prevent flow of the first fluid in a second direction, opposite the first direction, upon expansion of the compressed gas.

11. A method of operating a machine comprising:
compressing a gas within an accumulator to a first pressure with a first fluid;
selectively pressurizing the first fluid with the compressed gas to apply the first fluid to the machine; and
performing an operation of the machine with the pressurized first fluid.

12. The method of claim 11, further comprising selectively operating a pump to pressurize the first fluid.

13. The method of claim 12, wherein the pump comprises a pump assembly, and
wherein selectively operating a pump to pressurize a first fluid comprises operating the pump assembly with a second fluid to pressurize the first fluid.

14. The method of claim 13, wherein the pump assembly comprises:
a hydraulic motor portion operated by the second fluid; and
a pump portion that pressurizes the first fluid in response to operation of the hydraulic motor portion.

15. The method of claim 11, wherein selectively pressuring the first fluid with the compressed gas to apply the first fluid to the machine comprises selectively operating a first valve into a first configuration to direct flow of the pressurized first fluid to the accumulator to compress the gas and prevent flow of the first fluid to a location downstream of the accumulator.

16. The method of claim 15, wherein selectively pressuring the first fluid with the compressed gas to apply the first fluid to the machine comprises selectively operating the first valve into a second configuration to direct flow to the location downstream of the accumulator.

17. The method of claim 11, wherein compressing a gas within an accumulator with the pressurized first fluid comprises compressing the gas within the accumulator to a selected pressure with the pressurized first fluid and wherein the selected pressure is selected to accommodate a selected number of operations of the machine before recompression of the gas is performed.

18. The method of claim 11, wherein selectively operating a pump to pressurize a first fluid comprises operating a pump with a pressurized second fluid, and
wherein compressing a gas within an accumulator with the pressurized first fluid comprises flowing the pressurized first fluid into the accumulator in response to operation of the pump by the pressurized second fluid to compress the gas to a selected pressure and stopping flow of the pressurized first fluid upon the gas being compressed to the selected pressure.

19. The method of claim 18, wherein selectively pressuring the first fluid with the compressed gas to apply the first fluid to the machine comprises flowing the pressurized first fluid to the machine in response to at least partial expansion of the compressed gas.

20. The method of claim 11, wherein in the machine comprises a transmission and wherein performing an operation of the machine with the pressurized first fluid comprises shifting the transmission.

21. The method of claim 11, wherein selectively operating a pump to pressurize a first fluid comprises detecting a pressure of the gas in the accumulator and providing for operation of the pump when the detected pressure is equal to or less than a second pressure.
